(19) United States
(12) Patent Application Publication
(10) Pub. No.: US 2026/0046049 A1
(43) Pub. Date: Feb. 12, 2026

(54) SYNCHRONIZATION AND MEASUREMENT METHOD FOR LOW-POWER TERMINAL, TERMINAL, AND NETWORK-SIDE DEVICE

(71) Applicant: VIVO MOBILE COMMUNICATION CO., LTD., Dongguan (CN)

(72) Inventors: Jiansheng CAI, Dongguan (CN); Kai WU, Dongguan (CN); Xin QU, Dongguan (CN); Dongru LI, Dongguan (CN)

(21) Appl. No.: 19/299,786

(22) Filed: Aug. 14, 2025

Related U.S. Application Data
(63) Continuation of application No. PCT/CN2024/076754, filed on Feb. 7, 2024.

(30) Foreign Application Priority Data
Feb. 17, 2023 (CN) 202310140073.X

(51) Int. Cl. H04J 3/06; H04B 17/318; H04W 52/02

(52) U.S. Cl. CPC H04J 3/0635; H04B 17/328; H04W 52/0235

(57) ABSTRACT

This application discloses a synchronization and measurement method for a low power terminal, a terminal, and a network side device, and pertains to the field of communication technologies. The synchronization and measurement method for the low power terminal in embodiments of this application includes: In a case that a terminal detects a first sequence of a first signal, the terminal performs timing synchronization based on the first sequence, where the first signal includes the first sequence and a second sequence; and the terminal measures the second sequence, to obtain a target measurement result.

### CROSS-REFERENCE TO RELATED APPLICATIONS

This application is a bypass continuation application of International Application No. PCT/CN2024/076754, filed on Feb. 7, 2024, which claims the benefit of and priority to Chinese Patent Application No. 202310140073.X, filed on Feb. 17, 2023, the contents of both of which being incorporated by reference in their entireties herein.

### TECHNICAL FIELD

This application relates to the field of communication technologies and, more specifically, relates to a synchronization and measurement method for a low power terminal, a terminal, and a network side device.

### BACKGROUND

To reduce a terminal's receiving activity while in standby and to ensure that both its radio frequency module and baseband module are fully disabled, thereby greatly reducing communication-related power consumption, a low power wake-up receiver (LP-WUR) is introduced into the new radio (NR) system. The receiving end includes a first module and a second module. The first module is the main communication module, configured to send and receive mobile communication data. The second module is a low power wake-up receiving module, configured to receive a low power wake-up signal (LP-WUS). In an energy saving state, the terminal activates the low power receiving module to monitor the LP-WUS while keeping the main communication module disabled. When downlink data arrives, the network sends a wake-up signal to the terminal. Upon detecting the wake-up signal through the low power receiving module, the terminal, after performing a series of determinations, enables the main communication module. In this case, the low power receiving module switches from its operating state to a disabled state.

### BRIEF SUMMARY

Embodiments of this application provide a synchronization and measurement method for a low power terminal, a terminal, and a network side device.

According to a first aspect, a synchronization and measurement method for a low power terminal is provided. The method is performed by a terminal, and the method includes:

In a case that the terminal detects a first sequence of a first signal, the terminal performs timing synchronization based on the first sequence, where the first signal includes the first sequence and a second sequence; and
the terminal measures the second sequence, to obtain a target measurement result.

According to a second aspect, a synchronization and measurement method for a low power terminal is provided. The method is performed by a network side device, and the method includes:

The network side device sends a first signal to a terminal, where the first signal includes at least a first sequence and a second sequence, the first sequence is used to perform timing synchronization, and the second sequence is used to perform measurement.

According to a third aspect, a synchronization and measurement apparatus for a low power terminal is provided. The apparatus includes:
a processing module, configured to: in a case that a first sequence of a first signal is detected, perform timing synchronization based on the first sequence, where the first signal includes the first sequence and a second sequence; and
the processing module is further configured to measure the second sequence, to obtain a target measurement result.

According to a fourth aspect, a synchronization and measurement apparatus for a low power terminal is provided. The apparatus includes:
a sending module, configured to send a first signal to a terminal, where the first signal includes at least a first sequence and a second sequence, the first sequence is used to perform timing synchronization, and the second sequence is used to perform measurement.

According to a fifth aspect, a terminal is provided. The terminal includes a processor and a memory, the memory stores a program or an instruction that can be run on the processor, and when the program or the instruction is executed by the processor, steps of the method according to the first aspect are implemented.

According to a sixth aspect, a terminal is provided. The terminal includes a processor and a communication interface. The processor is configured to: in a case that the terminal detects a first sequence of a first signal, perform timing synchronization based on the first sequence, where the first signal includes the first sequence and a second sequence; and measure the second sequence, to obtain a target measurement result.

According to a seventh aspect, a network side device is provided. The network side device includes a processor and a memory, the memory stores a program or an instruction that can be run on the processor, and when the program or the instruction is executed by the processor, steps of the method according to the first aspect are implemented.

According to an eighth aspect, a network side device is provided. The network side device includes a processor and a communication interface. The communication interface is configured to send a first signal to a terminal, where the first signal includes at least a first sequence and a second sequence, the first sequence is used to perform timing synchronization, and the second sequence is used to perform measurement.

According to a ninth aspect, a readable storage medium is provided. The readable storage medium stores a program or an instruction, and when the program or the instruction is executed by a processor, steps of the method according to the first aspect are implemented, or steps of the method according to the second aspect are implemented.

According to a tenth aspect, a wireless communication system is provided. The system includes a terminal and a network side device. The terminal may be configured to perform steps of the method according to the first aspect, and the network side device may be configured to perform steps of the method according to the second aspect.

According to an eleventh aspect, a chip is provided. The chip includes a processor and a communication interface, the communication interface is coupled to the processor, and the processor is configured to run a program or an instruction, to implement the method according to the first aspect or the method according to the second aspect.

According to a twelfth aspect, a computer program/program product is provided. The computer program/program product is stored in a storage medium, and the program/program product is executed by at least one processor, to implement steps of the synchronization and measurement method for the low power terminal according to the first aspect or the second aspect.

### BRIEF DESCRIPTION OF DRAWINGS

FIG. 1 is a schematic diagram of a wireless communication system to which embodiments of this application are applicable;

FIG. 2 is a schematic diagram of a principle of a low power wake-up receiver according to an embodiment of this application;

FIG. 3 is a schematic diagram of an on-off keying signal according to an embodiment of this application;

FIG. 4 is a first schematic flowchart of a synchronization and measurement method for a low power terminal according to an embodiment of this application;

FIG. 5A is a first schematic diagram of a structure of a first signal of a synchronization and measurement method for a low power terminal according to an embodiment of this application;

FIG. 5B is a second schematic diagram of a structure of a first signal of a synchronization and measurement method for a low power terminal according to an embodiment of this application;

FIG. 5C is a third schematic diagram of a structure of a first signal of a synchronization and measurement method for a low power terminal according to an embodiment of this application;

FIG. 5D is a fourth schematic diagram of a structure of a first signal of a synchronization and measurement method for a low power terminal according to an embodiment of this application;

FIG. 6 is a second schematic flowchart of a synchronization and measurement method for a low power terminal according to an embodiment of this application;

FIG. 7 is a first schematic diagram of a structure of a synchronization and measurement apparatus for a low power terminal according to an embodiment of this application;

FIG. 8 is a second schematic diagram of a structure of a synchronization and measurement apparatus for a low power terminal according to an embodiment of this application;

FIG. 9 is a schematic diagram of a structure of a communication device according to an embodiment of this application;

FIG. 10 is a schematic diagram of a structure of a terminal according to an embodiment of this application; and

FIG. 11 is a schematic diagram of a structure of a network side device according to an embodiment of this application.

### DETAILED DESCRIPTION

The following describes technical solutions in embodiments of this application with reference to accompanying drawings in the embodiments of this application. Understandably, the described embodiments are some but not all of the embodiments of this application. All other embodiments obtained by a person of ordinary skill in the art based on embodiments of this application shall fall within the protection scope of this application.

The terms “first”, “second”, and the like in this application are used to distinguish between similar objects, instead of describing a specific order or sequence. It should be understood that the terms used in such a way are interchangeable in proper circumstances, so that embodiments of this application can be implemented in an order other than the order illustrated or described herein. Objects classified by “first” and “second” are usually of a same type, and a quantity of objects is not limited. For example, there may be one or more first objects. In addition, “or” in this application represents at least one of connected objects. For example, “A or B” covers three solutions. To be specific, Solution 1: A is included but B is not included; Solution 2: B is included but A is not included; and Solution 3: both A and B are included. The character “/” usually indicates an “or” relationship between associated objects.

The term “indication” in this application may be either a direct indication (or an explicit indication) or an indirect indication (or an implicit indication). The direct indication may be understood as that a sender explicitly notifies a receiver of content such as specific information, an operation that needs to be performed, or a request result in a sent indication. The indirect indication may be understood as that the receiver determines corresponding information based on an indication sent by the sender, or performs determining and determines an operation that needs to be performed, a request result, or the like based on a determining result.

It should be noted that the technologies described in the embodiments of this application are not limited to a long term evolution (LTE)/LTE-advanced (LTE-A) system, and may also be used in other wireless communication systems such as a code division multiple access (CDMA) system, a time division multiple access (TDMA) system, a frequency division multiple access (FDMA) system, an orthogonal frequency division multiple access (OFDMA) system, a single-carrier frequency division multiple access (SC-FDMA) system, or another system. The terms “system” and “network” in the embodiments of this application may be used interchangeably. The technologies described can be applied to both the systems and the radio technologies mentioned above as well as to other systems and radio technologies. A new radio (NR) system is described in the following descriptions for illustrative purposes, and the NR terminology is used in most of the following descriptions, although these technologies can also be applied to a system other than the NR system, for example, a 6^{th} generation (6G) communication system.

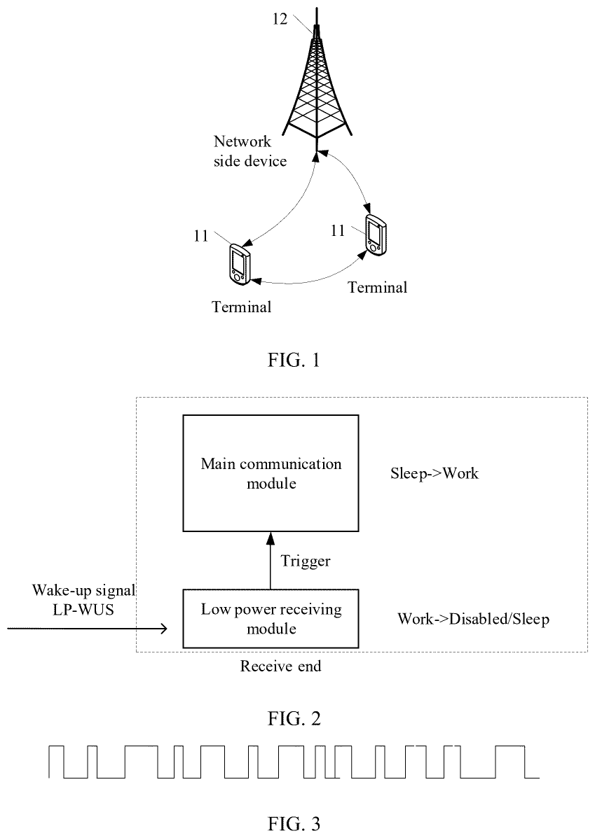

FIG. 1 is a block diagram of a wireless communication system to which embodiments of this application may be applied. The wireless communication system includes a terminal 11 and a network-side device 12. The terminal 11 may be a terminal side device, for example, a mobile phone, a tablet personal computer, a laptop computer, a notebook computer, a personal digital assistant (PDA), a palmtop computer, a netbook, an ultra-mobile personal computer (UMPC), a mobile internet device (MID), an augmented reality (AR) device, a virtual reality (VR) device, a robot, a wearable device, a flight vehicle, vehicle user equipment (VUE), maritime user equipment, pedestrian user equipment (PUE), a smart home (a home device having a wireless communication function, for example, a refrigerator, a television, a washing machine, or furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart anklet chain, or the like), a smart wrist strap, smart clothes, and the like. A vehicle-mounted device may also be referred to as a vehicle-mounted terminal, a vehicle-mounted controller, a vehicle-mounted module, a vehicle-mounted component, a vehicle-mounted chip, or a vehicle-mounted unit. It should be noted that a specific type of the terminal 11 is not limited in the embodiments of this application. The network side device 12 may include an access network device or a core network device. The access network device may also be referred to as a radio access network (RAN) device, a radio access network function, or a radio access network unit. The access network device may include a base station, a wireless local area network (WLAN) access point (AS), a wireless fidelity (Wi-Fi) node, or the like. The base station may be referred to as a NodeB (NB), an evolved NodeB (eNB), a next generation NodeB (gNB), a new radio NodeB (NR NodeB), an access point, a relay base station (RBS), a serving base station (SBS), a base transceiver station (BTS), a radio base station, a radio transceiver, a basic service set (BSS), an extended service set (ESS), a home NodeB (HNB), a home evolved NodeB, a transmission reception point (TRP), or another appropriate term in the field. Provided that same technical effect is achieved, the base station is not limited to a specified technical term. It should be noted that in the embodiments of this application, only a base station in an NR system is used as an example for description, and a specific type of the base station is not limited.

The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function unit (Policy and Charging Rules Function, PCRF), an edge application server discovery function (EASDF), a unified data management (UDM), a unified data repository (UDR), a home subscriber server (HSS), a centralized network configuration (CNC), a network repository function (NRF), a network exposure function (NEF), a local NEF (L-NEF), a binding support function (BSF), an application function (AF), and the like. It should be noted that, in the embodiments of this application, only a core network device in an NR system is used as an example for description, and a specific type of the core network device is not limited. The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF) unit, an edge application server discovery function (EASDF), a unified data management (UDM), a unified data repository (UDR), a home subscriber server (HSS), a centralized network configuration (CNC), a network repository function (NRF), a network exposure function (NEF), a local NEF (L-NEF), a binding support function (BSF), an application function (AF), and the like. It should be noted that in embodiments of this application, only a core network device in an NR system is used as an example for description, and a specific type of the core network device is not limited.

First, related concepts and scenarios in the embodiments of this application are described.

In 3GPP, research work of a low power wake-up receiver (LP-WUR)/a low power wake-up signal (LP-WUS) is introduced in a mobile cellular system starting from Rel-18. As shown in FIG. 2, a receive end includes a first module and a second module. The first module is a main communication module, configured to send and receive mobile communication data, and the second module is a low power wake-up receiving module, configured to receive the wake-up signal. In an energy saving state, a terminal enables the low power receiving module to monitor the LP-WUS and disables the main communication module. When downlink data arrives, a network sends a wake-up signal to the terminal. After detecting the wake-up signal through monitoring by using the low power receiving module, the terminal triggers, after a series of determining, the main communication module from being disabled to being enabled. In this case, the low power receiving module enters a disabled state from an operating state. The low power wake-up receiving module may be enabled continuously or intermittently, and may receive the low power wake-up signal when enabled.

To reduce receiving activities of the terminal in a standby state, enable a radio frequency (RF) and a baseband (modem) module to be truly disabled, thereby greatly reducing power consumption of communication receiving, a receiver with a near “zero” power may be introduced into the receiving module of the terminal. The receiver with the near “zero” power does not need complex RF module signal detection (for example, amplification, filtering, and quantization) and MODEM signal processing, and only depends on passive matched filtering and signal processing with low power consumption.

On a base station side, a wake-up signal is triggered on-demand, so that the receiver with the near “zero” power can be activated to learn of an activation notification, thereby triggering a series of procedures inside the terminal, for example, enabling a radio frequency transceiver module and a baseband processing module.

Usually, the wake-up signal is a simple on-off keying (OOK) signal. As shown in FIG. 3, the receiver may learn of a wake-up notification through a process such as simple energy detection and subsequent possible sequence detection and identification.

In a low power consumption scenario, time synchronization and measurement are also required. Therefore, how to implement time synchronization and measurement in the low power consumption scenario is a problem that needs to be resolved by a person skilled in the art.

Embodiments of this application provide a synchronization and measurement method for a low power terminal, a terminal, and a network side device, so that a problem of how to implement time synchronization and measurement in a low power consumption scenario can be resolved.

With reference to the accompanying drawings, the following describes in detail a synchronization and measurement method for a low power terminal provided in the embodiments of this application by using some embodiments and application scenarios thereof.

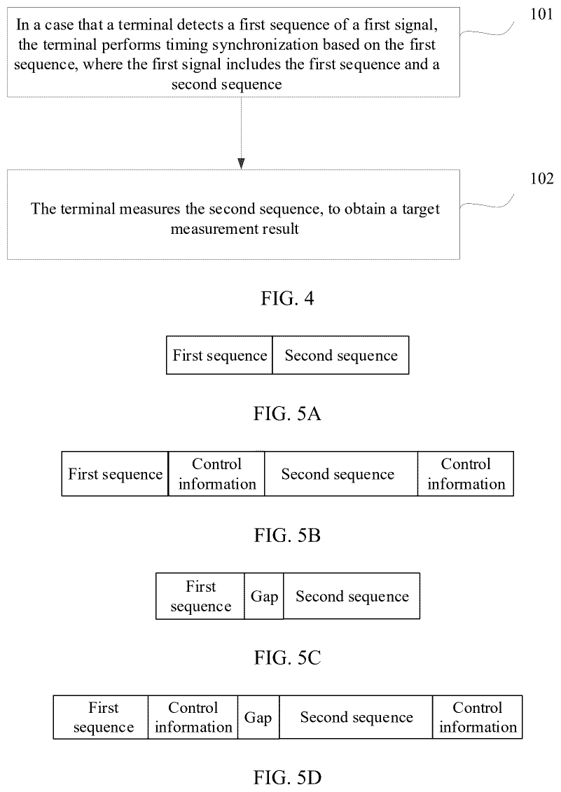

FIG. 4 is a first schematic flowchart of a synchronization and measurement method for a low power terminal according to an embodiment of this application. As shown in FIG. 4, the method includes the following steps.

Step 101: In a case that a terminal detects a first sequence of a first signal, the terminal performs timing synchronization based on the first sequence, where the first signal includes the first sequence and a second sequence.

Optionally, before step 101, the method further includes: The terminal receives the first signal.

Specifically, measurement of the terminal needs to be performed after time synchronization. Therefore, if there is only one synchronization signal in a measurement resource, the terminal cannot complete measurement based on only the synchronization signal. Therefore, a signal structure is required, and the terminal simultaneously completes synchronization and measurement based on the signal structure. In this embodiment of this application, time synchronization and measurement are implemented by using the first signal. The first signal includes at least the first sequence and the second sequence. In a case that the first sequence is detected, timing synchronization is performed based on the first sequence.

The terminal performs time-domain correlation calculation on the first sequence to obtain time synchronization information.

Step 102: The terminal measures the second sequence, to obtain a target measurement result.

Specifically, the terminal measures the second sequence in the first signal, to obtain the target measurement result, for example, performs mobility measurement or channel measurement.

Optionally, the first signal may also be referred to as a low power measurement signal (LP-MS) or a low power synchronization signal (Low Power Synchronize Signal, LP-SS)

Optionally, the first signal is repeatedly sent a plurality of times in one measurement periodicity, and the target measurement result is obtained based on a plurality of measurement results.

Optionally, the target measurement result includes at least one of the following: a signal-to-interference plus noise ratio (Signal to Noise and Interference Ratio, SINR), a reference signal received power (Reference Signal Receiving Power, RSRP), a received signal strength indication (RSSI), and a reference signal received quality (RSRQ).

Optionally, the first signal is a signal modulated by using a first modulation scheme, and the first modulation scheme includes at least one of the following: on-off keying OOK, amplitude shift keying (ASK), or frequency shift keying (FSK).

According to the method in this embodiment, in a case that the terminal detects the first sequence of the first signal, the terminal performs timing synchronization based on the first sequence, where the first signal includes the first sequence and the second sequence; and the terminal measures the second sequence of the first signal to obtain the target measurement result. In the foregoing solution, the low power terminal may simultaneously complete synchronization and measurement based on the first signal.

Optionally, the first sequence and the second sequence use different sequence structures.

Specifically, the first sequence may be referred to as a synchronization signal sequence, and the second sequence may also be referred to as a measurement signal sequence. Because the first sequence and the second sequence use different sequence structures, correlation is low, and two correlation peaks can be avoided during synchronization. Therefore, different designs can help improve synchronization accuracy and reduce measurement complexity.

Optionally, the second sequence may be further used for time synchronization, to improve time synchronization accuracy.

To achieve more accurate synchronization performance, when performing synchronization, the terminal performs joint timing synchronization on the first sequence and the second sequence. In this case, the second sequence may be a repetition of the first sequence, or may be a result of a design of a frame structure. For example, a synchronization signal sequence cannot be placed in one slot, the synchronization signal sequence is divided into the first sequence and the second sequence, and more accurate synchronization performance is obtained by detecting the two sequences. Optionally, the first signal further includes: at least one of control information and a gap sequence, the gap sequence is located between the first sequence and the second sequence, and the gap sequence is used for noise or interference measurement.

Specifically, the first signal includes at least the first sequence and the second sequence, and optionally, may further include at least one of the control information and the gap sequence (for example, referred to as a gap). For example, the control information is used to indicate a change of system information, the gap sequence is used for noise or interference measurement, and the required target measurement result may be obtained through calculation with reference to a measurement result of the second sequence.

In the foregoing implementation, the gap sequence is designed, to perform interference and noise measurement, so that measurement accuracy can be improved.

Optionally, format information of the first signal is configured by a network side device or predefined.

For example, the terminal receives configuration information of the network side device, where the configuration information is used to indicate the format information of the first signal.

As shown in FIG. 5A, the first signal includes the first sequence and the second sequence. As shown in FIG. 5B, the first signal includes the first sequence, the second sequence, and the control information, and there may be, for example, a plurality of pieces of control information. As shown in FIG. 5C, the first signal includes the first sequence, the second sequence, and the gap sequence, and the gap sequence is located between the first sequence and the second sequence. For example, the gap sequence may be used for interference or noise measurement. As shown in FIG. 5D, the first signal includes the first sequence, the second sequence, the control information, and the gap sequence.

The first signal may be implemented in different formats, which is more flexible.

Optionally, the control information includes at least one of the following: a quantity of repeatedly sending times of the first signal in one periodicity, an index of a quantity of repeatedly sending times, format information of a low power wake-up signal LP-WUS, a time domain length of the gap sequence, a cell identifier ID, and wake-up indication information.

Optionally, the control information is obtained through coding by using at least one coding scheme of Manchester encoding, pulse interval encoding (PIE), bi-phase space FMO (namely, Bi-Phase Space) encoding, Miller encoding, and Walsh encoding.

Optionally, the first sequence is a sequence in a limited sequence pool.

Specifically, the sequence pool of the first sequence is limited. This design facilitates the terminal to perform blind detection on the limited sequence pool, and detection efficiency is high.

Optionally, at least one of the first sequence and the second sequence is further used to indicate first information, and the first information includes at least one of the following: a cell identifier ID, a beam set index of the first signal, a beam index of the first signal, wake-up indication information, a time domain length of the gap sequence, and format information of a low power wake-up signal LP-WUS.

Specifically, the first sequence and/or the second sequence may carry other information, for example, the wake-up indication information, time domain length information of a gap part, a part of cell IDs, the beam set index (burst) of the first signal, the beam index (idx, for example, a most significant bit (MSB) or a least significant bit (LSB) of the beam index) of the first signal, the format information of the low power wake-up signal LP-WUS, and the like. A design of the carried information needs to be associated with a design of the first sequence/the second sequence, where the beam set index and the beam index of the first signal are similar to a burst and an index in a synchronization signal block (SSB). Alternatively, the first sequence may be configured by the network side device, predefined, or the like to notify, in advance, the terminal of information about the first sequence, for example, format information.

Optionally, the gap sequence is an all-0 sequence or another sequence; or the time domain length of the gap sequence is obtained based on at least one of the following: configuration information of the network side device, predefined information, the first sequence, or the control information.

Specifically, the gap sequence may be a segment of an all-0 sequence (nothing is sent), and is used as a measurement resource for interference or noise.

Time domain length information of the gap sequence may be configured by the network side device, or predefined (for example, related to a subcarrier spacing (SCS)), or may be obtained by using an indication of the first sequence and control information.

Optionally, the method further includes the following steps.

In a case that the terminal has learned of format information of the first sequence, the terminal performs correlation detection on the received first signal, to obtain the first sequence; or
in a case that the terminal does not learn of the format information of the first sequence, the terminal performs blind detection on the received first signal, to obtain the first sequence.

Optionally, in a case that the terminal does not detect the first sequence, the terminal does not perform the step of measuring the second sequence.

Specifically, the terminal first performs timing synchronization by using the first sequence. If the network side device preconfigures or predefines the format information of the first sequence and notifies the terminal of the format information of the first sequence, the terminal directly performs correlation detection by using a related sequence, that is, obtains a preset sequence based on the pre-learned format information of the first sequence; and performs a correlation operation on a received sequence. If a preset condition is met, for example, a correlation value is greater than a preset threshold, it indicates that the detected sequence is the first sequence; or if the network side device does not indicate the format information of the first sequence, the terminal performs blind detection on the first sequence. Optionally, the terminal may further obtain the corresponding wake-up indication information, time domain length information of the gap sequence, and the part of cell IDs, the beam set index of the first signal, the beam index of the first signal, the format information of the LP-WUS, and the like by using the detected first sequence.

In the foregoing implementation, correlation detection or blind detection is performed, so that signal detection efficiency is high.

Optionally, step 102 may be implemented in the following manner:

The terminal measures the gap sequence and the second sequence in the first signal, to obtain the target measurement result.

Specifically, after performing timing synchronization by using the first sequence of the first signal, the terminal performs radio resource management (RRM) measurement (for example, mobility measurement or channel measurement) and/or fine synchronization on the second sequence. If the first sequence is not detected, the terminal does not measure the second sequence, and does not record a measurement result this time. After the first sequence is detected, a time domain length of the gap is obtained based on the first sequence, interference or noise information is obtained by measuring the gap, and the target measurement result is obtained with reference to the measurement result of the second sequence.

Optionally, the terminal measures the gap sequence and the second sequence in the first signal, to obtain a plurality of initial measurement results; and
the terminal filters the plurality of initial measurement results, to obtain the target measurement result.

Specifically, the first signal is repeatedly sent a plurality of times in one measurement periodicity, a plurality of measurement results are recorded, and filtering is performed to obtain a final target measurement result. The filtering means performing weighted summation on the plurality of measurement results. Average weighted summation is performed if there is no special configuration; or may be configured by the network side device or predefined, and weights of last several measurement values are increased, to perform weighted summation.

In the foregoing implementation, measurement accuracy is improved by combining measurement of the gap sequence and filtering.

FIG. 6 is a second schematic flowchart of a synchronization and measurement method for a low power terminal according to an embodiment of this application. As shown in FIG. 6, the method includes the following steps.

Step 201: A network side device sends a first signal to a terminal, where the first signal includes at least a first sequence and a second sequence, the first sequence is used to perform timing synchronization, and the second sequence is used to perform measurement.

Optionally, the first sequence is different from the second sequence.

Optionally, the second sequence is further used to perform time synchronization.

Optionally, the first signal further includes: at least one of control information and a gap sequence, the gap sequence is located between the first sequence and the second sequence, and the gap sequence is used for noise or interference measurement.

Optionally, at least one of the first sequence and the second sequence is further used to indicate first information, and the first information includes at least one of the following: a cell identifier ID, a beam set index of the first signal, a beam index of the first signal, wake-up indication information, a time domain length of the gap sequence, and format information of a low power wake-up signal LP-WUS.

Optionally, the control information includes at least one of the following: a quantity of repeatedly sending times of the first signal in one periodicity, an index of a quantity of repeatedly sending times, format information of a low power wake-up signal LP-WUS, a time domain length of the gap sequence, a cell identifier ID, and wake-up indication information.

Optionally, the first sequence is a sequence in a limited sequence pool; or
the time domain length of the gap sequence is obtained based on at least one of the following: configuration information of the network side device, predefined information, the first sequence, or the control information.

Optionally, format information of the first signal is configured by the network side device or predefined.

Optionally, the target measurement result includes at least one of the following: a signal-to-interference plus noise ratio SINR, a reference signal received power RSRP, a received signal strength indication RSSI, and a reference signal received quality RSRQ.

Optionally, the first signal is a signal modulated by using a first modulation scheme, and the first modulation scheme includes at least one of the following: on-off keying OOK, amplitude shift keying ASK, or frequency shift keying FSK.

Optionally, the control information is obtained through coding by using at least one coding scheme of Manchester encoding, pulse interval encoding PIE, bi-phase space FM0 encoding, Miller encoding, and Walsh encoding.

A specific implementation process and technical effect of the method in this embodiment are the same as those in the method embodiment on the terminal side. For details, refer to the detailed descriptions in the method embodiment on the terminal side. Details are not described herein again.

The synchronization and measurement method for the low power terminal provided in the embodiments of this application may be performed by a synchronization and measurement apparatus for a low power terminal. In the embodiments of this application, an example in which the synchronization and measurement apparatus for the low power terminal performs the synchronization and measurement method for the low power terminal is used to describe the synchronization and measurement apparatus for the low power terminal provided in the embodiments of this application.

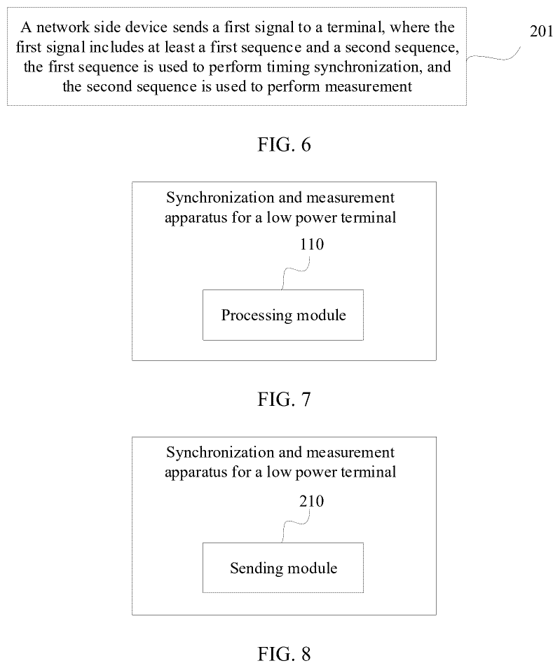

FIG. 7 is a first schematic diagram of a structure of a synchronization and measurement apparatus for a low power terminal according to an embodiment of this application. As shown in FIG. 7, the synchronization and measurement apparatus for the low power terminal is used in a terminal, and includes:
a processing module 110, configured to: in a case that a first sequence of a first signal is detected, perform timing synchronization based on the first sequence, where the first signal includes the first sequence and a second sequence; and
the processing module 110 is further configured to measure the second sequence, to obtain a target measurement result.

Optionally, the first sequence is different from the second sequence.

Optionally, the second sequence is further used to perform time synchronization.

Optionally, the first signal further includes: at least one of control information and a gap sequence, the gap sequence is located between the first sequence and the second sequence, and the gap sequence is used for noise or interference measurement.

Optionally, at least one of the first sequence and the second sequence is further used to indicate first information, and the first information includes at least one of the following: a cell identifier ID, a beam set index of the first signal, a beam index of the first signal, wake-up indication information, a time domain length of the gap sequence, and format information of a low power wake-up signal LP-WUS.

Optionally, the control information includes at least one of the following: a quantity of repeatedly sending times of the first signal in one periodicity, an index of a quantity of repeatedly sending times, format information of a low power wake-up signal LP-WUS, a time domain length of the gap sequence, a cell identifier ID, and wake-up indication information.

Optionally, the first sequence is a sequence in a limited sequence pool; or
the time domain length of the gap sequence is obtained based on at least one of the following: configuration information of a network side device, predefined information, the first sequence, or the control information.

Optionally, format information of the first signal is configured by the network side device or predefined.

Optionally, the processing module 110 is further configured to:
in a case that the terminal has learned of format information of the first sequence, perform correlation detection on the received first signal, to obtain the first sequence; or
in a case that the terminal does not learn of the format information of the first sequence, perform blind detection on the received first signal, to obtain the first sequence.

Optionally, the processing module 110 is further configured to:
in a case that the terminal does not detect the first sequence, not perform the step of measuring the second sequence.

Optionally, the processing module 110 is specifically configured to:
measure the gap sequence and the second sequence in the first signal, to obtain the target measurement result.

Optionally, the processing module 110 is specifically configured to:
measure the gap sequence and the second sequence in the first signal, to obtain a plurality of initial measurement results; and
filter the plurality of initial measurement results, to obtain the target measurement result.

Optionally, the target measurement result includes at least one of the following: a signal-to-interference plus noise ratio SINR, a reference signal received power RSRP, a received signal strength indication RSSI, and a reference signal received quality RSRQ.

Optionally, the first signal is a signal modulated by using a first modulation scheme, and the first modulation scheme includes at least one of the following: on-off keying OOK, amplitude shift keying ASK, or frequency shift keying FSK.

Optionally, the control information is obtained through coding by using at least one coding scheme of Manchester encoding, pulse interval encoding PIE, bi-phase space FMO encoding, Miller encoding, and Walsh encoding.

The apparatus in this embodiment may be configured to perform the method in any one of the method embodiments on the terminal side. A specific implementation process and technical effect of the apparatus are the same as those in the method embodiment on the terminal side. For details, refer to the detailed descriptions in the method embodiment on the terminal side. Details are not described herein again.

FIG. 8 is a second schematic diagram of a structure of a synchronization and measurement apparatus for a low power terminal according to an embodiment of this application. As shown in FIG. 8, the synchronization and measurement apparatus for the low power terminal is used in a network side device, and includes:
a sending module 210, configured to send a first signal to a terminal, where the first signal includes at least a first sequence and a second sequence, the first sequence is used to perform timing synchronization, and the second sequence is used to perform measurement.

Optionally, the first sequence is different from the second sequence. Optionally, the second sequence is further used to perform time synchronization.

Optionally, the first signal further includes: at least one of control information and a gap sequence, the gap sequence is located between the first sequence and the second sequence, and the gap sequence is used for noise or interference measurement.

Optionally, at least one of the first sequence and the second sequence is further used to indicate first information, and the first information includes at least one of the following: a cell identifier ID, a beam set index of the first signal, a beam index of the first signal, wake-up indication information, a time domain length of the gap sequence, and format information of a low power wake-up signal LP-WUS.

Optionally, the control information includes at least one of the following: a quantity of repeatedly sending times of the first signal in one periodicity, an index of a quantity of repeatedly sending times, format information of a low power wake-up signal LP-WUS, a time domain length of the gap sequence, a cell identifier ID, and wake-up indication information.

Optionally, the first sequence is a sequence in a limited sequence pool; or
the time domain length of the gap sequence is obtained based on at least one of the following: configuration information of the network side device, predefined information, the first sequence, or the control information.

Optionally, format information of the first signal is configured by the network side device or predefined.

Optionally, the target measurement result includes at least one of the following: a signal-to-interference plus noise ratio SINR, a reference signal received power RSRP, a received signal strength indication RSSI, and a reference signal received quality RSRQ.

Optionally, the first signal is a signal modulated by using a first modulation scheme, and the first modulation scheme includes at least one of the following: on-off keying OOK, amplitude shift keying ASK, or frequency shift keying FSK.

Optionally, the control information is obtained through coding by using at least one coding scheme of Manchester encoding, pulse interval encoding PIE, bi-phase space FMO encoding, Miller encoding, and Walsh encoding.

The apparatus in this embodiment may be configured to perform the method in any one of the method embodiments on the network side device. A specific implementation process and technical effect of the apparatus are the same as those in the method embodiment on the network side device. For details, refer to the detailed descriptions in the method embodiment on the network side device. Details are not described herein again.

The synchronization and measurement apparatus for the low power terminal in the embodiment of this application may be an electronic device, for example, an electronic device having an operating system, or may be a component in the electronic device, for example, an integrated circuit or a chip. The electronic device may be a terminal, or may be a device other than the terminal. For example, the terminal may include but is not limited to the foregoing listed types of the terminal 11, and the another device may be a server, a network attached storage (NAS), or the like. This is not specifically limited in this embodiment of this application.

The synchronization and measurement apparatus for the low power terminal provided in this embodiment of this application can implement processes implemented in the method embodiment in FIG. 4 to FIG. 6, and same technical effect is achieved. To avoid repetition, details are not described herein again.

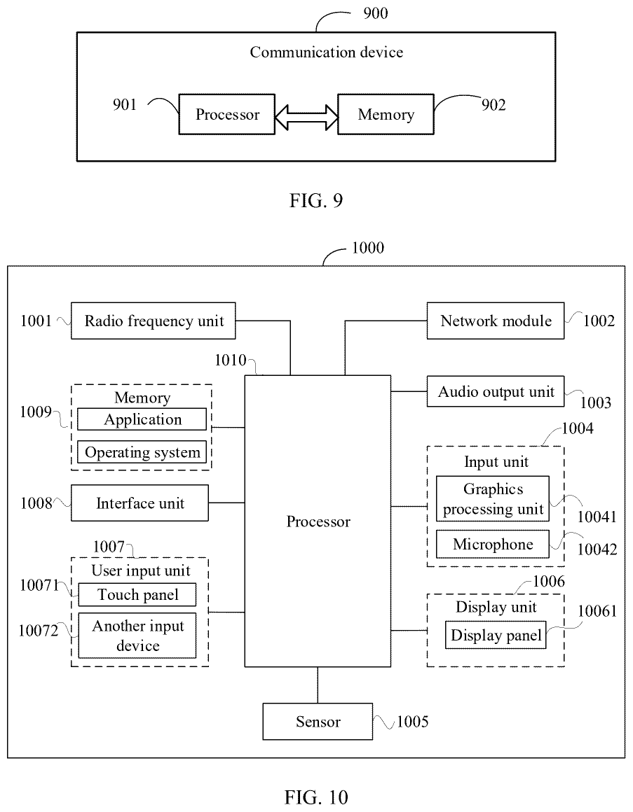

As shown in FIG. 9, an embodiment of this application further provides a communication device 900. The communication device 900 includes a processor 901 and a memory 902, and the memory 902 stores a program or an instruction that can be run on the processor 901. For example, when the communication device 900 is a terminal, the program or the instruction is executed by the processor 901, steps of the embodiment of the foregoing synchronization and measurement method for the low power terminal are implemented, and same technical effect can be achieved. When the communication device 900 is a network side device, and the program or the instruction is executed by the processor 901, steps of the embodiment of the foregoing synchronization and measurement method for the low power terminal are implemented, and same technical effect can be achieved. To avoid repetition, details are not described herein again.

An embodiment of this application further provides a terminal. The terminal includes a processor and a communication interface, the communication interface is coupled to the processor, and the processor is configured to run a program or an instruction, to implement the steps in the method embodiment shown in FIG. 4. The terminal embodiment corresponds to the method embodiment on the terminal side, each implementation process and implementation of the method embodiment can be applied to the terminal embodiment, and same technical effect can be achieved. Specifically, FIG. 10 is a schematic diagram of a hardware structure of a terminal according to an embodiment of this application.

The terminal 1000 includes but is not limited to at least some components in a radio frequency unit 1001, a network module 1002, an audio output unit 1003, an input unit 1004, a sensor 1005, a display unit 1006, a user input unit 1007, an interface unit 1008, a memory 1009, a processor 1010, and the like.

A person skilled in the art can understand that the terminal 1000 may further include a power supply (such as a battery) that supplies power to each component. The power supply may be logically connected to the processor 1010 by using a power supply management system, to implement functions such as charging and discharging management, and power consumption management by using the power supply management system. The structure of the terminal shown in FIG. 10 constitutes no limitation on the terminal, and the terminal may include more or fewer components than those shown in the figure, or combine some components, or have different component arrangements. Details are not described herein.

It should be understood that in this embodiment of this application, the input unit 1004 may include a graphics processing unit (GPU) 10041 and a microphone 10042. The graphics processing unit 10041 processes image data of a static picture or a video obtained by an image capture apparatus (for example, a camera) in a video capture mode or an image capture mode. The display unit 1006 may include a display panel 10061, and the display panel 10061 may be configured in a form of a liquid crystal display, an organic light-emitting diode, or the like. The user input unit 1007 includes at least one of a touch panel 10071 and another input device 10072. The touch panel 10071 is also referred to as a touchscreen. The touch panel 10071 may include two parts: a touch detection apparatus and a touch controller. The another input device 10072 may include, but is not limited to, a physical keyboard, a function key (such as a volume control key or an on/off key), a trackball, a mouse, and a joystick. Details are not described herein again.

In this embodiment of this application, the radio frequency unit 1001 receives downlink data from a network side device and then sends the downlink data to the processor 1010 for processing; and the radio frequency unit 1001 may send uplink data to the network side device. Usually, the radio frequency unit 1001 includes but is not limited to an antenna, at least one amplifier, a transceiver, a coupler, a low noise amplifier, a duplexer, and the like.

The memory 1009 may be configured to store a software program or an instruction and various data. The memory 1009 may mainly include a first storage area for storing a program or an instruction and a second storage area for storing data. The first storage area may store an operating system, and an application or an instruction required by at least one function (for example, a sound playing function or an image playing function). In addition, the memory 1009 may include a volatile memory or a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synchlink DRAM, SLDRAM), and a direct rambus random access memory (Direct Rambus RAM, DR RAM). The memory 1009 in this embodiment of this application includes but is not limited to these memories and any memory of another proper type.

The processor 1010 may include one or more processing units. Optionally, an application processor and a modem processor are integrated into the processor 1010. The application processor mainly processes an operating system, a user interface, an application, and the like. The modem processor mainly processes a wireless communication signal, for example, a baseband processor. It may be understood that, alternatively, the modem processor may not be integrated into the processor 1010.

The processor 1010 is configured to: in a case that a first sequence of a first signal is detected, perform timing synchronization based on the first sequence, where the first signal includes the first sequence and a second sequence; and
the processor 1010 is further configured to measure the second sequence, to obtain a target measurement result.

Optionally, the first sequence is different from the second sequence.

Optionally, the second sequence is further used to perform time synchronization.

Optionally, the first signal further includes: at least one of control information and a gap sequence, the gap sequence is located between the first sequence and the second sequence, and the gap sequence is used for noise or interference measurement.

Optionally, at least one of the first sequence and the second sequence is further used to indicate first information, and the first information includes at least one of the following: a cell identifier ID, a beam set index of the first signal, a beam index of the first signal, wake-up indication information, a time domain length of the gap sequence, and format information of a low power wake-up signal LP-WUS.

Optionally, the control information includes at least one of the following: a quantity of repeatedly sending times of the first signal in one periodicity, an index of a quantity of repeatedly sending times, format information of a low power wake-up signal LP-WUS, a time domain length of the gap sequence, a cell identifier ID, and wake-up indication information.

Optionally, the first sequence is a sequence in a limited sequence pool; or
the time domain length of the gap sequence is obtained based on at least one of the following: configuration information of the network side device, predefined information, the first sequence, or the control information.

Optionally, format information of the first signal is configured by the network side device or predefined.

Optionally, the processing module 110 is further configured to:
in a case that the terminal has learned of format information of the first sequence, perform correlation detection on the received first signal, to obtain the first sequence; or
in a case that the terminal does not learn of the format information of the first sequence, perform blind detection on the received first signal, to obtain the first sequence.

Optionally, the processing module 110 is further configured to:
in a case that the terminal does not detect the first sequence, not perform the step of measuring the second sequence.

Optionally, the processing module 110 is specifically configured to:
measure the gap sequence and the second sequence in the first signal, to obtain the target measurement result.

Optionally, the processing module 110 is specifically configured to:
measure the gap sequence and the second sequence in the first signal, to obtain a plurality of initial measurement results; and
filter the plurality of initial measurement results, to obtain the target measurement result.

Optionally, the target measurement result includes at least one of the following: a signal-to-interference plus noise ratio SINR, a reference signal received power RSRP, a received signal strength indication RSSI, and a reference signal received quality RSRQ.

Optionally, the first signal is a signal modulated by using a first modulation scheme, and the first modulation scheme includes at least one of the following: on-off keying OOK, amplitude shift keying ASK, or frequency shift keying FSK.

Optionally, the control information is obtained through coding by using at least one coding scheme of Manchester encoding, pulse interval encoding PIE, bi-phase space FMO encoding, Miller encoding, and Walsh encoding.

It may be understood that, for an implementation process of the implementations mentioned in this embodiment, refer to related descriptions of the method embodiment on the terminal side, and same or corresponding technical effect may be achieved. To avoid repetition, details are not described herein again.

An embodiment of this application further provides a network side device. The network side device includes a processor and a communication interface, the communication interface is coupled to the processor, and the processor is configured to run a program or an instruction, to implement the steps of the method embodiment shown in FIG. 6. The network side device embodiment corresponds to the method embodiment of the network side device, each implementation process and implementation of the method embodiment can be applied to the network side device embodiment, and same technical effect can be achieved.

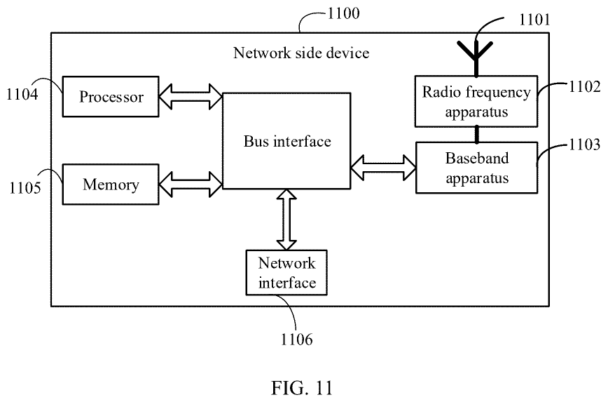

Specifically, an embodiment of this application further provides a network side device. As shown in FIG. 11, the network side device 1100 includes an antenna 1101, a radio frequency apparatus 1102, a baseband apparatus 1103, a processor 1104, and a memory 1105. The antenna 1101 is connected to the radio frequency apparatus 1102. In an uplink direction, the radio frequency apparatus 1102 receives information through the antenna 1101, and sends the received information to the baseband apparatus 1103 for processing. In a downlink direction, the baseband apparatus 1103 processes information that needs to be sent, and sends processed information to the radio frequency apparatus 1102. The radio frequency apparatus 1102 processes the received information, and sends processed information through the antenna 1101.

In the foregoing embodiment, the method performed by the network side device may be implemented in the baseband apparatus 1103. The baseband apparatus 1103 includes a baseband processor.

The baseband apparatus 1103 may include, for example, at least one baseband board. A plurality of chips are disposed on the baseband board. As shown in FIG. 11, one chip is, for example, a baseband processor, and is connected to the memory 1105 through a bus interface, to invoke a program in the memory 1105, to perform the operations of the network side device shown in the foregoing method embodiments.

The network side device may further include a network interface 1106, and the interface is, for example, a common public radio interface (CPRI).

Specifically, the network side device 1100 in this embodiment of this application further includes an instruction or a program that is stored in the memory 1105 and that can be run on the processor 1104. The processor 1104 invokes the instruction or the program in the memory 1105 to perform the method performed by the modules shown in FIG. 8, and same technical effect is achieved. To avoid repetition, details are not described herein again.

An embodiment of this application further provides a readable storage medium. The readable storage medium stores a program or an instruction, and when the program or the instruction is executed by a processor, processes of the embodiment of the foregoing synchronization and measurement method for the low power terminal are implemented, and same technical effect can be achieved. To avoid repetition, details are not described herein again.

The processor is a processor in the terminal in the foregoing embodiments. The readable storage medium includes a computer-readable storage medium, for example, a computer read-only memory ROM, a random access memory RAM, a magnetic disk, or an optical disc. In some examples, the readable storage medium may be a non-transient readable storage medium.

An embodiment of this application further provides a chip. The chip includes a processor and a communication interface, the communication interface is coupled to the processor, the processor is configured to run a program or an instruction, to implement processes of the embodiment of the foregoing synchronization and measurement method for the low power terminal, and same technical effect can be achieved. To avoid repetition, details are not described herein again.

It should be understood that the chip mentioned in this embodiment of this application may also be referred to as a system-level chip, a system chip, a chip system, or a system-on-a-chip chip.

An embodiment of this application further provides a computer program/program product. The computer program/program product is stored in a storage medium, the computer program/program product is executed by at least one processor, to implement processes of the embodiment of the foregoing synchronization and measurement method for the low power terminal, and same technical effect can be achieved. To avoid repetition, details are not described herein again.

An embodiment of this application further provides a communication system. The communication system includes: a terminal and a network side device. The terminal may be configured to perform steps of the foregoing synchronization and measurement method for the low power terminal, and the network side device may be configured to perform steps of the foregoing synchronization and measurement method for the low power terminal.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and apparatus in the embodiments of this application is not limited to performing functions in the order shown or discussed, but may also include performing the functions in a basically simultaneous manner or in opposite order based on the functions involved. For example, the described method may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiments may be implemented by using a computer software product in addition to a necessary universal hardware platform, or certainly may be implemented by hardware. The computer software product is stored in a storage medium (such as a ROM, a RAM, a magnetic disk, or an optical disc), and includes several instructions for instructing a terminal or a network side device to perform the method described in the embodiments of this application.

Embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms of implementations without departing from the purpose of this application and the protection scope of the claims, all of the implementations fall within the protection of this application.

1. A synchronization and measurement method for a low power terminal, comprising:
in a case that a terminal detects a first sequence of a first signal, performing, by the terminal, timing synchronization based on the first sequence, wherein the first signal comprises the first sequence and a second sequence; and
measuring, by the terminal, the second sequence, to obtain a target measurement result.

2. The synchronization and measurement method for the low power terminal according to claim 1, wherein the second sequence is further used to perform time synchronization.

3. The synchronization and measurement method for the low power terminal according to claim 1, wherein the first signal further comprises: at least one of control information or a gap sequence, and the gap sequence is located between the first sequence and the second sequence.

4. The synchronization and measurement method for the low power terminal according to claim 3, wherein
at least one of the first sequence or the second sequence is further used to indicate first information, and the first information comprises at least one of the following: a cell identifier ID, a beam set index of the first signal, a beam index of the first signal, wake-up indication information, a time domain length of the gap sequence, or format information of a low power wake-up signal LP-WUS.

5. The synchronization and measurement method for the low power terminal according to claim 3, wherein
the control information comprises at least one of the following: a quantity of repeatedly sending times of the first signal in one periodicity, an index of a quantity of repeatedly sending times, format information of a low power wake-up signal LP-WUS, a time domain length of the gap sequence, a cell identifier ID, or wake-up indication information.

6. The synchronization and measurement method for the low power terminal according to claim 3, wherein
the first sequence is a sequence in a limited sequence pool; or
the time domain length of the gap sequence is obtained based on at least one of the following: configuration information of a network side device, predefined information, the first sequence, or the control information.

7. The synchronization and measurement method for the low power terminal according to claim 1, wherein the method further comprises:
in a case that the terminal has learned of format information of the first sequence, performing, by the terminal, correlation detection on the received first signal, to obtain the first sequence; or
in a case that the terminal does not learn of the format information of the first sequence, performing, by the terminal, blind detection on the received first signal, to obtain the first sequence.

8. The synchronization and measurement method for the low power terminal according to claim 1, wherein the method further comprises:
in a case that the terminal does not detect the first sequence, not performing, by the terminal, the step of measuring the second sequence.

9. The synchronization and measurement method for the low power terminal according to claim 3, wherein the measuring, by the terminal, the second sequence of the first signal, to obtain a target measurement result comprises:
measuring, by the terminal, the gap sequence and the second sequence in the first signal, to obtain the target measurement result.

10. The synchronization and measurement method for the low power terminal according to claim 9, wherein the measuring, by the terminal, the gap sequence and the second sequence in the first signal, to obtain the target measurement result comprises:
measuring, by the terminal, the gap sequence and the second sequence, to obtain a plurality of initial measurement results; and
filtering, by the terminal, the plurality of initial measurement results, to obtain the target measurement result.

11. The synchronization and measurement method for the low power terminal according to claim 1, wherein the target measurement result comprises at least one of the following: a signal-to-interference plus noise ratio SINR, a reference signal received power RSRP, a received signal strength indication RSSI, or a reference signal received quality RSRQ.

12. The synchronization and measurement method for the low power terminal according to claim 1, wherein the first signal is a signal modulated by using a first modulation scheme, and the first modulation scheme comprises at least one of the following: on-off keying OOK, amplitude shift keying ASK, or frequency shift keying FSK.

13. The synchronization and measurement method for the low power terminal according to claim 3, wherein
the control information is obtained through coding by using at least one coding scheme of Manchester encoding, pulse interval encoding PIE, bi-phase space FMO encoding, Miller encoding, or Walsh encoding.

14. A synchronization and measurement method for a low power terminal, comprising:
sending, by a network side device, a first signal to a terminal, wherein the first signal comprises at least a first sequence and a second sequence, the first sequence is used to perform timing synchronization, and the second sequence is used to perform measurement.

15. The synchronization and measurement method for the low power terminal according to claim 14, wherein the second sequence is further used to perform time synchronization.

16. The synchronization and measurement method for the low power terminal according to claim 14, wherein the first signal further comprises: at least one of control information or a gap sequence, and the gap sequence is located between the first sequence and the second sequence.

17. The synchronization and measurement method for the low power terminal according to claim 16, wherein
at least one of the first sequence or the second sequence is further used to indicate first information, and the first information comprises at least one of the following: a cell identifier ID, a beam set index of the first signal, a beam index of the first signal, wake-up indication information, a time domain length of the gap sequence, or format information of a low power wake-up signal LP-WUS.

18. The synchronization and measurement method for the low power terminal according to claim 16, wherein
the control information comprises at least one of the following: a quantity of repeatedly sending times of the first signal in one periodicity, an index of a quantity of repeatedly sending times, format information of a low power wake-up signal LP-WUS, a time domain length of the gap sequence, a cell identifier ID, or wake-up indication information.

19. A terminal, comprising at least one hardware processor and a memory having program instructions stored thereon that are executable by the at least one hardware processor that, when executed, direct the at least one hardware processor to:
in a case that the terminal detects a first sequence of a first signal, perform timing synchronization based on the first sequence, wherein the first signal comprises the first sequence and a second sequence; and
measure the second sequence, to obtain a target measurement result.

20. A network side device, comprising at least one hardware processor and a memory having program instructions stored thereon executable by the at least one hardware processor that, when executed, direct the at least one hardware processor to perform the synchronization and measurement method for the low power terminal according to claim 14.
